(19) United States
(12) Patent Application Publication
(10) Pub. No.: US 2021/0144928 A1
(43) Pub. Date: May 20, 2021

(54) INLINE BALE WRAPPING APPARATUS WITH ACTIVATABLE DISPLACEMENT ASSISTANCE SYSTEM

(71) Applicant: GROUPE ANDERSON INC., Chesterville (CA)

(72) Inventors: Alexandre GIGUÈRE, St-Christophe d'Arthabaska (CA); Patrice DESROCHERS, St-Christophe d'Arthabaska (CA); Jacques BRETON, Chesterville (CA); Michaël GAGNON-BOUCHARD, Ham-Nord (CA)

(21) Appl. No.: 16/689,637

(22) Filed: Nov. 20, 2019

(51) Int. Cl. A01F 15/08; A01F 15/07

(52) U.S. Cl. CPC A01F 15/0875; A01F 2015/074; A01F 15/071

(57) ABSTRACT

An inline bale wrapping including a bale loading support structure, a bale wrapping mechanism, a bale unloading support structure, a displacement assembly and a displacement assistance system. The bale loading support structure has a bale pushing mechanism driving unwrapped bales in a bale displacement direction, towards a wrapping section having a wrapping mechanism dispensing wrapping film around the multiple bales driven therethrough. The bale unloading support receives and support wrapped bales travelling towards an adjacent ground surface. The displacement assembly is operative to move the inline bale wrapping apparatus in an apparatus displacement direction opposite to the bale displacement direction. The displacement assistance system is operatively connected to the displacement assembly and is activatable to assist the operation of the displacement assembly to minimize a driving force required to move the inline bale wrapping apparatus in the apparatus displacement direction, while the bales are laid on the ground.

### TECHNICAL FIELD OF THE INVENTION

The present invention relates to the field of bale wrapping machinery. More particularly, it relates to an apparatus designed to perform inline bale wrapping of multiple adjacent bales, with a specific operation of the apparatus while the first bales of a tube of bales are laid on the ground to minimize movement of the firsts bales on the ground and the corresponding damaging of the wrapping that could be caused by the rubbing of the wrapping on the ground surface.

### BACKGROUND

In the field of agriculture, it is common to use wrapping apparatuses, such as inline wrappers for wrapping together multiple bales of crop such as, for example and without being limitative hay, straw, corn straw or the like, to form a tube containing multiple bales adjacent to one another. The wrapped bales can subsequently be stored to eventually turn the crop into fodder.

In such devices, in order to minimize the displacement of the tube of bales on the ground surface onto which the tube is laid after being wrapped (which is undesirable as it can damage the wrapping of the tube and negatively impact the quality of the fodder), the apparatus is usually displaceable, to move with regard to the ground surface in a direction opposite to the direction of movement of the multiple bales being wrapped along the frame of the apparatus, as the bales are laid on the ground subsequently to being wrapped into the tube. However, given that it is also desirable that the bales be compressed against one another to minimize air pockets in the tube (i.e. it is desirable that adjacent end surfaces of two consecutive bales be pressed against one another with a sufficient force to minimize air gaps between bales in the tube), it is common for inline bale wrappers to offer a resistance to the above-described displacement with regard to the ground surface. Such resistance causes the inline bale wrapper to move only when a predetermined driving force is imparted on the apparatus by the bales being pushed out of the apparatus and onto the ground, after being compressed against one another with the desired force to perform the desired compression. Such a driving force can be imparted on the apparatus only once a sufficient length of tube has been laid on the ground to create enough friction between the tube and the ground surface to prevent movement of the tube with regard to the ground surface and therefore causes the force generated by the pressure exerted onto the bale by the apparatus to generate the required driving force on the apparatus. For example, the resistance can be imparted by the moving members, such as wheels or the like, supporting the frame of the apparatus onto the ground having a resistance to rolling thereof. Even in cases where no restriction is applied to the rotative movement of the wheels supporting the frame of the apparatus, the inertia of the apparatus resulting from its weight causes the inline bale wrapper to offer a resistance to the above-described displacement regarding the ground surface.

In view of the above, known devices tend to lead to a displacement (a rubbing) of the tube of bales on the ground surface onto which the tube is laid after being wrapped, before a sufficient amount of bales are laid on the ground to impart the required driving force for the apparatus to be displaced in the direction opposite to the direction of movement of the multiple bales being wrapped along the frame of the apparatus, hence potentially damaging the wrapping of the tube and negatively impacting the quality of the fodder. To alleviate such problems, it is common for operators to manually position a voluminous stop object (such as additional bales, a concrete block or the like) on the ground, close to the end of the apparatus where the bales exit the apparatus and are laid on the ground, to retain the first bale of the tube and prevent displacement of the tube on the ground (i.e. for the sufficient driving force to be imparted on the apparatus when even the first bales of the tube are pushed out of the apparatus). Alternatively, operators can operate the apparatus to continuously drive the apparatus in the direction opposite to the direction of movement of the multiple bales being wrapped along the frame, while the firsts bales of the beginning of the tube are laid on the ground, to prevent displacement of the bales on the ground, and manually switch to normal operation mode once a sufficient number of bales have been laid on the ground for subsequent bales to impart the required driving force to move the apparatus when pushed out of the apparatus, without displacement of the bales with regard to the ground surface.

As mentioned above, the displacement of the initial section of the tube of bales with regard to the ground surface, which occurs when no additional operator actions are performed, is undesirable as it can lead to lower fodder quality made with the wrapped crop. Similarly, the additional manual operations by the operators are also undesirable as they result in additional steps that need to be performed by the operator and therefore lead to economic loss resulting from the time lost doing such additional steps and/or the additional manpower required to do so.

In view of the above, there is a need for an improved wrapping apparatus, which, by virtue of their design and components, would be able to overcome or at least minimize some of the above-discussed prior art concerns.

### BRIEF SUMMARY OF THE INVENTION

In accordance with a first general aspect, there is provided an inline bale wrapping apparatus for wrapping multiple successive bales into a tube. The inline bale wrapping apparatus extends along a longitudinal axis and comprises a bale loading support structure, a bale wrapping mechanism, a bale unloading support structure, a displacement assembly and a displacement assistance system. The bale loading support structure is configured to successively receive unwrapped bales and includes a bale pushing mechanism movable along the longitudinal axis and engageable to a corresponding one of the unwrapped bales to drive the corresponding one of the unwrapped bales in a bale displacement direction, towards a wrapping section defined downstream of the bale loading structure. The bale wrapping mechanism is positioned in the wrapping section and dispenses wrapping film around the multiple bales being successively driven through the wrapping section to form the tube. The bale unloading support structure is positioned downstream of the wrapping section and receives wrapped bales forming the tube from the bale wrapping mechanism, the wrapped bales travelling onto the bale unloading support structure towards an adjacent ground surface. The displacement assembly supports the bale loading support structure, the bale wrapping mechanism and the bale unloading support structure on the ground surface and is operative to move the inline bale wrapping apparatus in an apparatus displacement direction relative to the ground surface and opposite to the bale displacement direction. The displacement assistance system is operatively connected to the displacement assembly and is activatable to assist the operation of the displacement assembly to minimize a driving force required to move the inline bale wrapping apparatus in the apparatus displacement direction.

In an embodiment, the displacement assistance system is deactivatable and provides no assistance to the operation of the displacement assembly when being deactivated.

In an embodiment, the displacement assembly includes at least one set of motorized moving members. The displacement assistance system activates a motor of the at least one set of motorized moving members, when activated and operating, to assist the movement of the displacement assembly.

In an embodiment, the displacement assistance system includes a fluid flow controller controlling a fluid flow to the bale pushing mechanism and the bale wrapping mechanism and the displacement assistance system redirects a portion of the fluid flow of at least one of the bale pushing mechanism and the bale wrapping mechanism towards the at least one set of motorized moving members, when activated and operating.

In an embodiment, the displacement assistance system includes a fluid flow controller controlling a fluid flow to the bale pushing mechanism and the bale wrapping mechanism and the fluid flow controller controls a fluid flow towards the at least one set of motorized moving members according to the fluid flow provided to at least one of the bale pushing mechanism and the bale wrapping mechanism, when activated and operating.

In an embodiment, the displacement assistance system is operatively connected to the bale pushing mechanism and the bale wrapping mechanism and is operating only during the operation of the bale pushing mechanism and the bale wrapping mechanism.

In an embodiment, the inline bale wrapping apparatus further comprises a chassis supporting the bale loading support structure, the bale wrapping mechanism and the bale unloading support structure, the displacement assembly being mounted to the chassis and moving the chassis with regards to the ground surface.

In an embodiment, the bale pushing mechanism includes a bale engaging member extending upwardly and engageable to a rear surface of the corresponding bale of the unwrapped bales, when the corresponding bale is being driven towards the wrapping section by the action of the bale pushing mechanism.

In an embodiment, the bale wrapping mechanism includes a frame having a central bore and at least one film-carrying apparatus drivable along the frame to rotate around the successive bales moved through the central bore and dispense wrapping film around the bales to form the tube.

In an embodiment, the bale unloading support structure includes conveying elements allowing free movement of the tube of bales about the bale unloading support structure and towards the adjacent ground surface.

In accordance with another general aspect, there is also provided an inline bale wrapping apparatus for wrapping multiple successive bales into a tube. The inline bale wrapping apparatus extends along a longitudinal axis and comprises a chassis having mounted thereon: a bale loading support structure, a bale wrapping mechanism and a bale unloading support. The inline bale wrapping apparatus also comprises a displacement assembly and a displacement assistance system. The bale loading support structure receives unwrapped bales and has a bale pushing mechanism movable along the longitudinal axis and successively pushing the unwrapped bales in a bale displacement direction, towards a wrapping section defined immediately downstream of the bale loading structure. The bale wrapping mechanism is positioned in the wrapping section and dispenses wrapping film around bales positioned in the wrapping section to form the tube. The bale unloading support structure is immediately downstream of the wrapping section and receives the tube of bales from the bale wrapping mechanism, the tube of bales traveling onto the bale unloading support structure towards an adjacent ground surface and generating a tube driving force exerted in a direction opposite to the bale displacement direction. The displacement assembly supports the chassis on the ground surface and is operative to move the chassis in an apparatus displacement direction relative to the ground surface and opposite to the bale displacement direction. The displacement assistance system is operatively connected to the displacement assembly and is activable to assist the operation of the displacement assembly to minimize the tube driving force required to to move the chassis in the apparatus displacement direction.

In an embodiment, the displacement assistance system is deactivatable and provides no assistance to the operation of the displacement assembly when being deactivated.

In an embodiment, the displacement assembly includes at least one set of motorized moving members, the displacement assistance system activating a motor of the at least one set of motorized moving members, when activated and operating, to assist the movement of the displacement assembly.

In an embodiment, the displacement assistance system includes a fluid flow controller controlling a fluid flow to the bale pushing mechanism and the bale wrapping mechanism and the displacement assistance system redirects a portion of the fluid flow of at least one of the bale pushing mechanism and the bale wrapping mechanism towards the at least one set of motorized moving members, when activated and operating.

In an embodiment, the displacement assistance system includes a fluid flow controller controlling a fluid flow to the bale pushing mechanism and the bale wrapping mechanism. The fluid flow controller controls a fluid flow towards the at least one set of moving members according to the fluid flow provided to at least one of the bale pushing mechanism and the bale wrapping mechanism, when activated and operating.

In an embodiment, the displacement assistance system is operatively connected to the bale pushing mechanism and the bale wrapping mechanism and is operating only during the operation of the bale pushing mechanism and the bale wrapping mechanism.

In an embodiment, the bale pushing mechanism includes a bale engaging member extending upwardly and engageable to a rear surface of each corresponding unwrapped bales, when the corresponding bale is being pushed towards the wrapping section by the action of the bale pushing mechanism.

In an embodiment, the bale wrapping mechanism includes a frame having a central bore and at least one film-carrying apparatus drivable along the frame to rotate around the bales moved through the central bore and dispense wrapping film around the bales to form the tube.

In an embodiment, the bale unloading support structure includes conveying elements allowing free movement of the tube of bales about the bale unloading support structure and towards the adjacent ground surface.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a perspective view of the inline bale wrapper in accordance with an embodiment.

FIG. 2 is a schematic representation of the components of the inline bale wrapper in accordance with an embodiment.

FIG. 3 is a detailed schematic representation of the components of the inline bale wrapper of FIG. 2, in accordance with an embodiment.

FIG. 4 is a detailed schematic representation of the components of the inline bale wrapper of FIG. 2, in accordance with an alternative embodiment.

FIGS. 5A to 5I are views of the inline bale wrapping apparatus of FIG. 1 showing a sequence of operation for operation of the bale wrapping apparatus, wherein:

FIGS. 5A and 5B are respectively a left side elevation view and a front elevation view of the inline bale wrapping apparatus with the first bale in a wrapping section and being wrapped by a bale wrapping mechanism.

FIG. 5C is a left side elevation view of the wrapping apparatus with a second bale loaded on the bale loading support structure, while the first bale is being wrapped.

FIG. 5D is a left side elevation view of the wrapping apparatus with the second bale positioned in the wrapping section and being wrapped along with the first bale, in a single tube.

FIG. 5E is a left side elevation view of the wrapping apparatus with a third bale loaded on the bale loading support structure, while the second bale is being wrapped.

FIG. 5F is a left side elevation view of the wrapping apparatus with the third bale entering the wrapping section to be wrapped along with the second bale and the first bale, in the single tube.

FIG. 5G is a left side elevation view of the wrapping apparatus with the third bale further into the wrapping section to be wrapped along with the second bale and the first bale, in the single tube.

FIG. 5H is a left side elevation view of the wrapping apparatus with a fourth bale loaded on the bale loading support structure, while the third bale is being wrapped.

FIG. 5I is a left side elevation view of the wrapping apparatus with the fourth bale positioned in the wrapping section and being wrapped along with the third bale, the second bale and the first bale, in the single tube.

### DETAILED DESCRIPTION

In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures or described in the present disclosure are embodiments only, given solely for exemplification purposes.

Moreover, although the embodiments of the wrapping apparatus and corresponding parts thereof consist of certain geometrical configurations as explained and illustrated herein, not all of these components and geometries are needed and thus should not be taken in their restrictive sense. It is to be understood, as also apparent to a person skilled in the art, that other suitable components and cooperation thereinbetween, as well as other suitable geometrical configurations, may be used for the wrapping mechanism protection apparatus, as will be briefly explained herein and as can be easily inferred herefrom by a person skilled in the art. It will also be appreciated that positional descriptions such as “downstream”, “upstream”, “above”, “below”, “left”, “right” and the like should, unless otherwise indicated, be taken in the context of the figures and correspond to the position and orientation of the wrapping apparatus and corresponding parts shown in the Figures, with “upstream” corresponding to a position closer to a bale loading support structure of the inline bale wrapping apparatus and the end of the tube of bales that is initially formed (i.e. the end of the tube of bales that is first formed by the wrapping of the first bale of the tube) and “downstream” corresponding to a position closer to a bale unloading support structure of the inline bale wrapping apparatus and the end of the tube of bales that is lastly formed (i.e. the end of the tube of bales that is formed by the wrapping of the last bale of the tube). Positional descriptions should not be considered limiting.

To provide a more concise description, some of the quantitative and qualitative expressions given herein may be qualified with the terms “about” and “substantially”. It is understood that whether the terms “about” and “substantially” are used explicitly or not, every quantity or qualification given herein is meant to refer to an actual given value or qualification, and it is also meant to refer to the approximation to such given value or qualification that would reasonably be inferred based on the ordinary skill in the art, including approximations due to the experimental and/or measurement conditions for such given value.

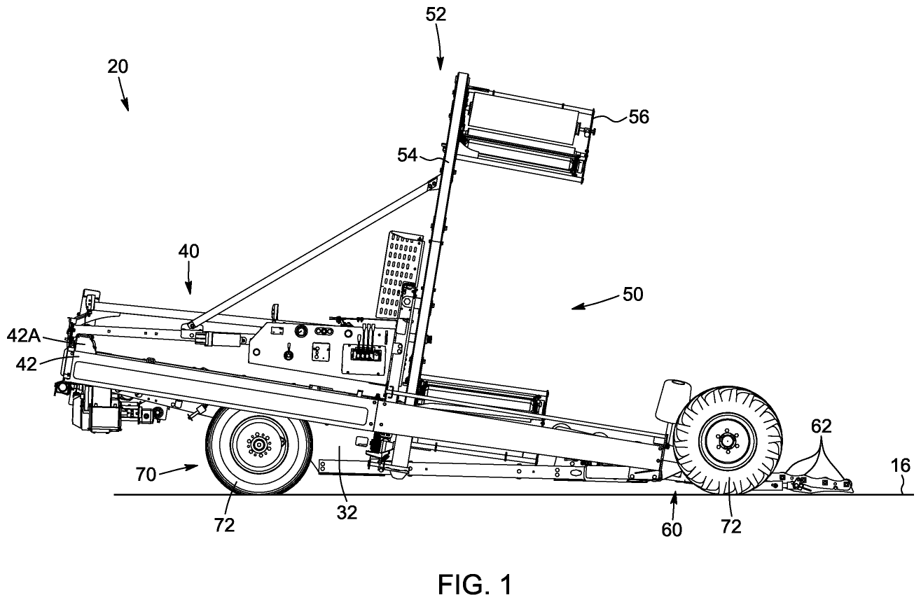

Referring now to the drawings and more particularly to FIGS. 1 to 5I, there is shown an inline bale wrapping apparatus 20 for wrapping together multiple adjacent bales 30A, 30B, 30C, 30D of crop such as, for example and without being limitative, hay, haylage, straw, corn straw, etc. or any combination thereof, thereby forming a tube 18 containing the multiple bales 30A, 30B, 30C, 30D wrapped together. The inline bale wrapping apparatus 20 is configured to receive the multiple bales 30A, 30B, 30C, 30D in a longitudinal orientation (i.e. to receive the bales 30A, 30B, 30C, 30D in an orientation where they are longitudinally substantially parallel to a longitudinal axis L), successively perform the wrapping of the multiple adjacent bales 30A, 30B, 30C, 30D moved along the apparatus 20, in a bale displacement direction D along the longitudinal axis L, and finally lay the resulting tube 18 of multiple wrapped bales 30A, 30B, 30C, 30D on a ground surface 16 supporting the apparatus 20.

More particularly, the multiple bales 30A, 30B, 30C, 30D are successively wrapped on their rounded peripheral surface. In an embodiment (not shown), the substantially flat ends of the first bale 30A (the downstream bale) and the last bale 30D (the upstream bale) of the tube 18 which define the extremities of the tube 18 of successive bales 30A, 30B, 30C, 30D can also be wrapped to ensure sealing of the tube 18 and prevent spoilage of the fodder. One skilled in the art will understand that, wrapping of the substantially flat ends of the first bale 30A and the last bale 30D of the tube 18 which define the extremities of the tube 18 can be performed before or after the inline wrapping described below and will not be described in detail herein. It will also be understood that the tube 18 may have various lengths according to the number of bales wrapped, no specific limitations being created by the inline bale wrapping apparatus 20 for the number of successive bales that can be wrapped. One skilled in the art will understand that although the bales 30A, 30B, 30C, 30D discussed in the present description and shown in the appended Figures have a cylindrical shape, in alternative embodiments (not shown) the bales 30A, 30B, 30C, 30D could have a different shape, such as, for example and without being limitative, a square shape, a rectangular shape or the like. In an embodiment, the multiple adjacent bales 30A, 30B, 30C, 30D are wrapped with a plastic film to promote, for instance, fermentation in the production of fodder or silage.

As will be easily understood by one skilled in the art, the inline bale wrapping apparatus 20 described herein is presented as an apparatus designed for wrapping bales of crop, but one skilled in the art will understand that, in alternative embodiments (not shown) the apparatus could be used to wrap bales of a different material or could be used to wrap other objects such as and without being limitative boxes, packages, bundles of items or the like.

In the embodiment shown, the inline bale wrapping apparatus 20 comprises a bale loading support structure 40, a bale wrapping mechanism 52 and a bale unloading support structure 60 positioned successively along the longitudinal axis L of the inline bale wrapping apparatus 20. The inline bale wrapping apparatus 20 also comprises a chassis 32 onto which the bale loading support structure 40, the bale wrapping mechanism 52 and the bale unloading support structure 60 are mounted and a displacement assembly 70. For example and without being limitative, in an embodiment, the displacement assembly 70 includes at least one set of motorized moving members 72, such as, for instance driving wheels mounted on an axle (not shown) of the chassis 32, to enable the displacement of the chassis 32 (and consequently the displacement of the inline bale wrapping apparatus 20) about the ground surface 16 onto which it is supported. In other words, in an embodiment, the chassis 32 and the displacement assembly 70, operate as a carriage for supporting and displacing the inline bale wrapping apparatus 20 including the bale loading support structure 40, bale wrapping mechanism 52 and bale unloading support structure 60. One skilled in the art will understand that, in alternative embodiments (not shown) the displacement assembly 70 could include different moving members 72 than the driving wheels of the embodiment shown, such as, for example and without being limitative, tracks or the like.

The bale loading support structure 40 is sized, shaped and/or configured such as to receive unwrapped bales. In an embodiment, the bale loading support structure 40 comprises a bale pushing mechanism 42 (or pusher) which is movable longitudinally along the bale loading support structure 40 (i.e. movable in a direction substantially parallel to longitudinal axis L) to drive an unwrapped bale towards a wrapping section 50 including the wrapping mechanism 52. In the embodiment shown, the bale pushing mechanism 42 has a bale engaging member 42A extending upwardly and engageable to a rear surface (or upstream surface) of a bale 30A, 30B, 30C, 30D, when the corresponding bale 30A, 30B, 30C, 30D is being driven towards the wrapping section 50 by the action of the bale pushing mechanism 42.

The bale unloading support structure 60 is positioned downstream of the wrapping section 50 and is sized, shaped and configured such as to receive wrapped bales 30A, 30B, 30C, 30D from the bale wrapping mechanism 52, with the bales 30A, 30B, 30C, 30D travelling onto the bale unloading support structure 60, towards an adjacent ground surface 16. In the embodiment shown, the bale unloading support structure 60 includes a plurality of free rolling rollers 62 operating as conveying elements to allow the free movement of the tube 18 of bales 30A, 30B, 30C, 30D about the bale unloading support structure 60 and towards the adjacent ground surface 16 and preventing damage to the wrapping of the tube 18. One skilled in the art will understand that, in alternative embodiments (not shown), other types of conveying elements such as a conveyor belt or the like could be used.

When the tube 18 of bales engages the ground surface 16 and subsequent bales 30A, 30B, 30C, 30D are pushed towards the wrapping section 50 by the bale pushing mechanism 42 to be wrapped and added to the tube 18, a tube driving force is exerted on the inline bale wrapping apparatus 20, in a direction opposite to the bale displacement direction and corresponding to an apparatus displacement direction D′.

The bale wrapping mechanism 52 is positioned in the wrapping section 50 defined between the bale loading support structure 40 and the bale unloading support structure 60 along the longitudinal axis L of the inline bale wrapping apparatus 20. In the embodiment shown, the bale wrapping mechanism 52 includes a frame 54 having a central bore 54A (or hollow middle section) and at least one film-carrying apparatus 56 which is drivable onto/along frame 54 to rotate around the successive bales 30A, 30B, 30C, 30D moved through the central bore 54A and dispense wrapping film around the bales 30A, 30B, 30C, 30D to form the tube 18.

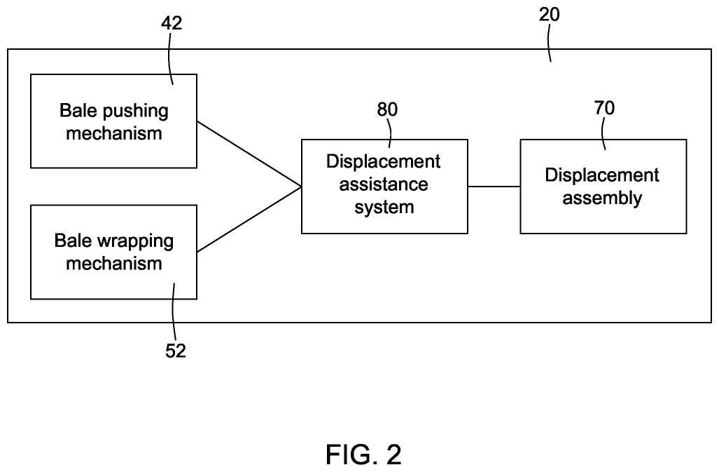

Referring to FIGS. 2 to 4, in an embodiment, the inline bale wrapping apparatus 20 further includes a displacement assistance system 80 configured to at least temporarily assist the displacement of the the inline bale wrapping apparatus 20 while a downstream section 18′ of the tube 18 of bales is laid on the ground surface 16. Hence, when activated and operative, the displacement assistance system 80 helps to minimize the displacement of the downstream section 18′ of the tube 18 relative to the ground surface 16 by assisting the operation of the displacement assembly 70 and therefore minimizing the tube driving force required by the action of the tube 18 of bales being pushed out to displace the inline bale wrapping apparatus 20. In an embodiment, the displacement assistance system 80 is operating only when it is activated and when the bale wrapping mechanism 52 is also operating to wrap bales located in the wrapping section 50.

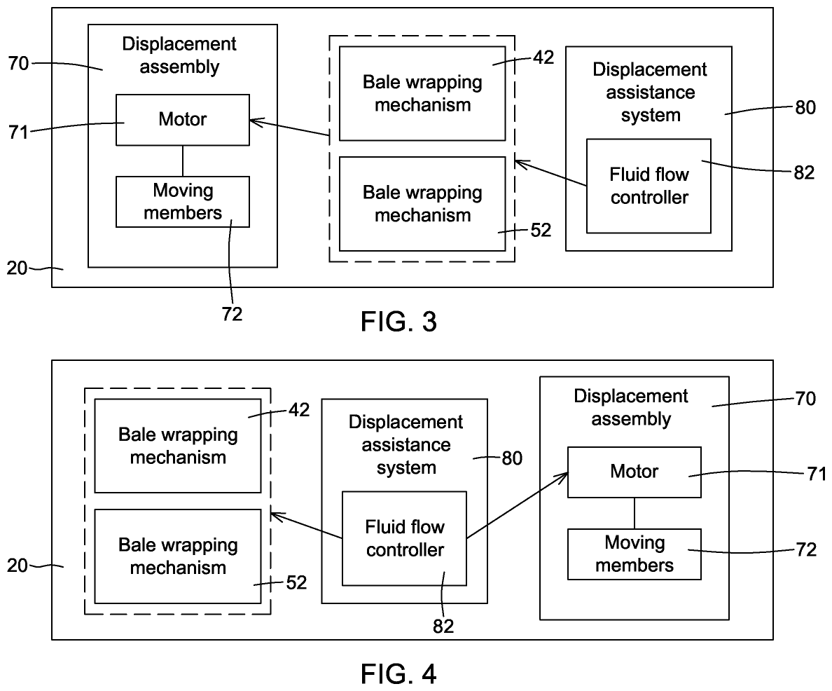

Referring to FIG. 3, in an embodiment, the displacement assistance system 80 includes a fluid flow controller 82 operative to control the fluid flow towards components of the inline bale wrapping apparatus 20, including the bale pushing mechanism 42 and the bale wrapping mechanism 52. In this embodiment, the displacement assistance system 80 operates to redirect a portion of the fluid flow of at least one of the bale pushing mechanism 42 and the bale wrapping mechanism 52 towards the moving members 72 of the displacement assembly 70 (or towards a motor 71 thereof), during the operation of the bale pushing mechanism 42 and the bale wrapping mechanism 52 to activate the motor 71 and assist the movement of the moving members 72, such that they can rotate and cause movement of the inline bale wrapping apparatus 20 in the apparatus displacement direction D′ (i.e. the direction opposite to the bale displacement direction D), with a minimal driving force being exerted on the wrapping apparatus 20 by the action of the tube 18 of bales being pushed out of the bale unloading support structure 60, as will be described in more details below. In an embodiment, the fluid flow controller 82 is a hydraulic controller controlling a hydraulic flow.

In an alternative embodiment shown in FIG. 4, the displacement assistance system 80 again includes a fluid flow controller 82 operative to control the fluid flow towards components of the inline bale wrapping apparatus 20, including the bale pushing mechanism 42, the bale wrapping mechanism 52 and the displacement assembly 70. In this embodiment, the fluid flow controller 82 directly controls the fluid flow towards the moving members 72 of the displacement assembly 70 (or towards a motor 71 thereof), according to the fluid flow provided to at least one of the bale pushing mechanism 42 and the bale wrapping mechanism 52, during the operation of the bale pushing mechanism 42 and the bale wrapping mechanism 52 to activate the motor 71 and assist the movement of the moving members 72, such that they can rotate and cause movement of the inline bale wrapping apparatus 20 in a apparatus displacement direction D′, with a minimal driving force being exerted on the wrapping apparatus 20 by the action of the tube 18 of bales being pushed out of the bale unloading support structure 60, as will be described in more details below. Once again, in an embodiment, the fluid flow controller 82 is a hydraulic controller controlling a hydraulic flow.

One skilled in the art will understand that, in another alternative embodiments (not shown) other types of controllers could be operatively connected to any type of mechanism which provides assistance to the movement of the moving members 72 of the displacement assembly 70, such as the driving wheels. For example and without being limitative, the controller can control the mechanism which provides assistance to the movement of the components of the displacement assembly 70 based on data received from sensor (not shown) sensing data relative to at least one of the bale pushing mechanism 42, the bale wrapping mechanism 42, or the section of tube 18 being laid on the ground 16.

In view of the above, it is understood that, when activated, the displacement assistance system 80 operates to assist the movement of the displacement assembly 70 only while the bale pushing mechanism 42 and/or the bale wrapping mechanism 52 are in operation, given that it is during this time that sections of the tube 18 are laid on the ground 16 and the displacement assistance system 80 is required to operate to ease the displacement of the inline bale wrapping apparatus 20 in the apparatus displacement direction D′ and therefore prevent (or at least minimize) the movement of the section of the tube 18 onto the ground surface 16. It will also be understood that the displacement assistance system 80 does not provide a sufficient power to the displacement assembly 70 to impart movement to the inline bale wrapping apparatus 20 (or the chassis 32 thereof) in itself, the movement of the inline bale wrapping apparatus 20 in the apparatus displacement direction D′ occurring only when a driving force is exerted thereon by the movement of the tube 18 exiting the bale unloading support structure 60, as additional bales are pushed by the bale pushing mechanism 42.

In an embodiment, the operation of the displacement assistance system 80 results in a driving force of between about 500 Newtons and about 2 000 Newtons exerted on the inline bale wrapping apparatus 20, in the apparatus displacement direction D′, being sufficient to displace the apparatus in the apparatus displacement direction D′. More particularly, in an embodiment, the operation of the displacement assistance system 80 results in a driving force of between about 750 Newtons and about 1 250 Newtons exerted on the inline bale wrapping apparatus 20, in the apparatus displacement direction D′, being sufficient to displace the apparatus 20 in the apparatus displacement direction D′.

In an embodiment, the displacement assistance system 80 can be activated to operate while a downstream section 18′ of the tube 18 is being laid on the ground surface 16 and deactivated such that is prevented from operating to allow greater compression between bales in the tube 18 of bales once a sufficient section of tube 18 is laid on the ground 16 to generate the required friction to cause the downstream section 18′ of tube 18 projecting from the apparatus 20 to remain static and generate the required tube driving force to overcome the inertia of the apparatus 20 and/or the additional restriction to movement thereof and displace the apparatus 20 in the apparatus displacement direction D′.

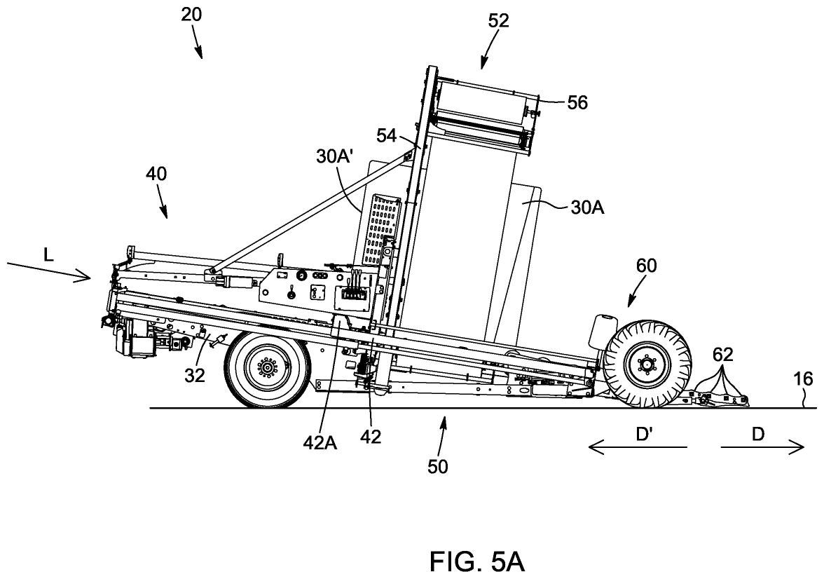

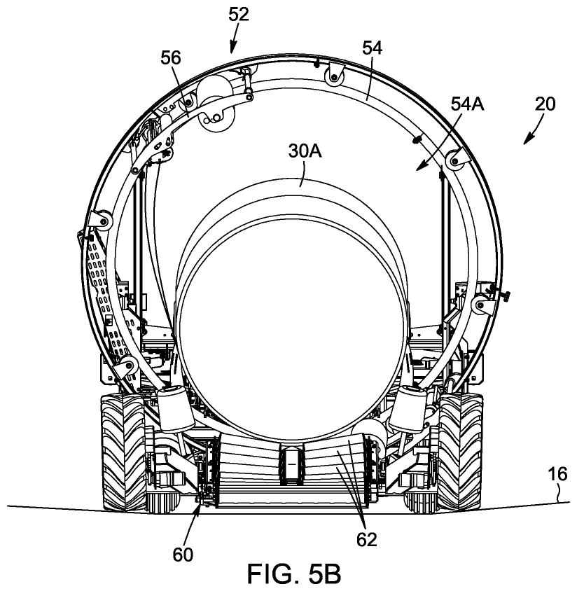

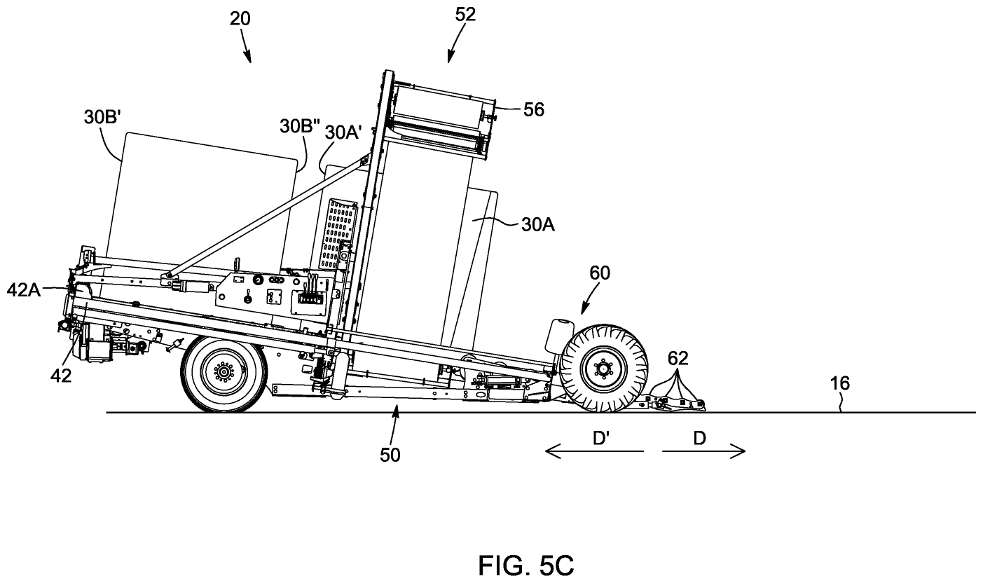

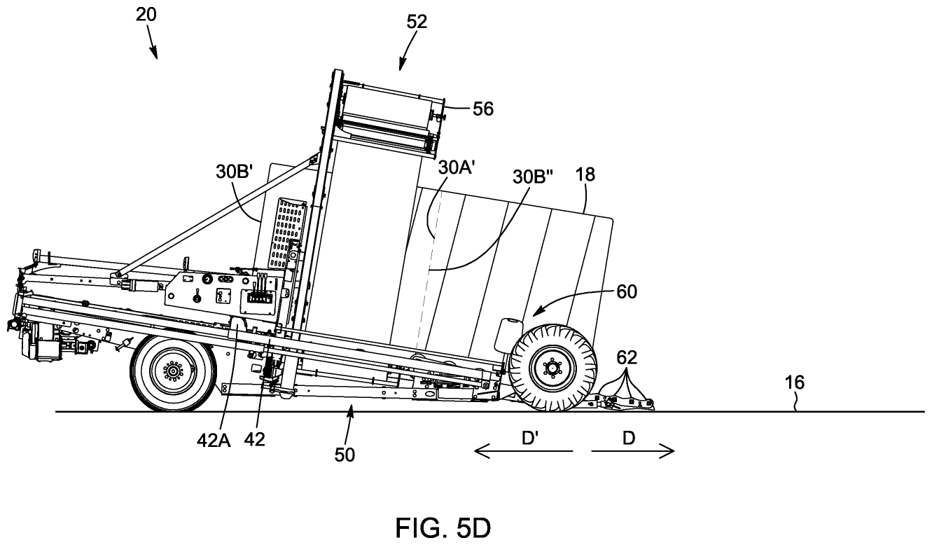

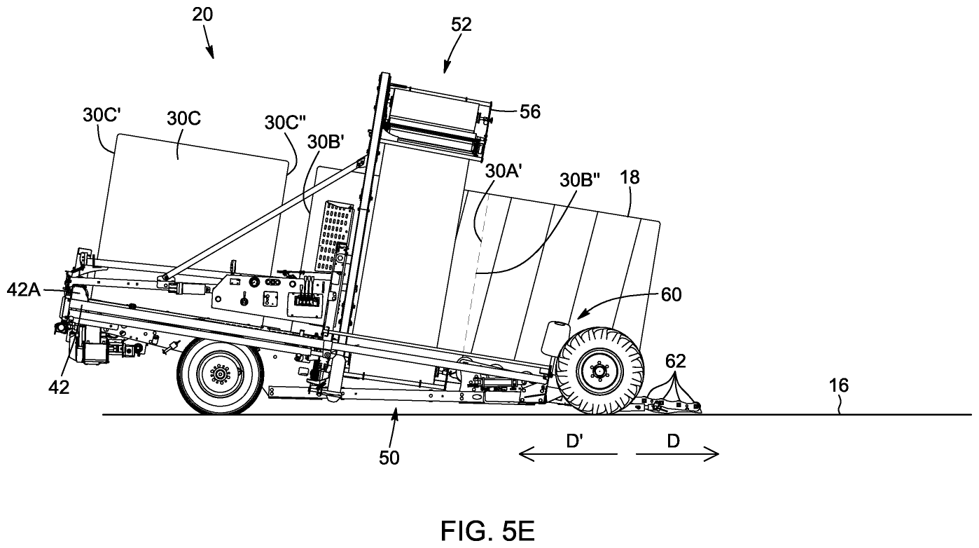

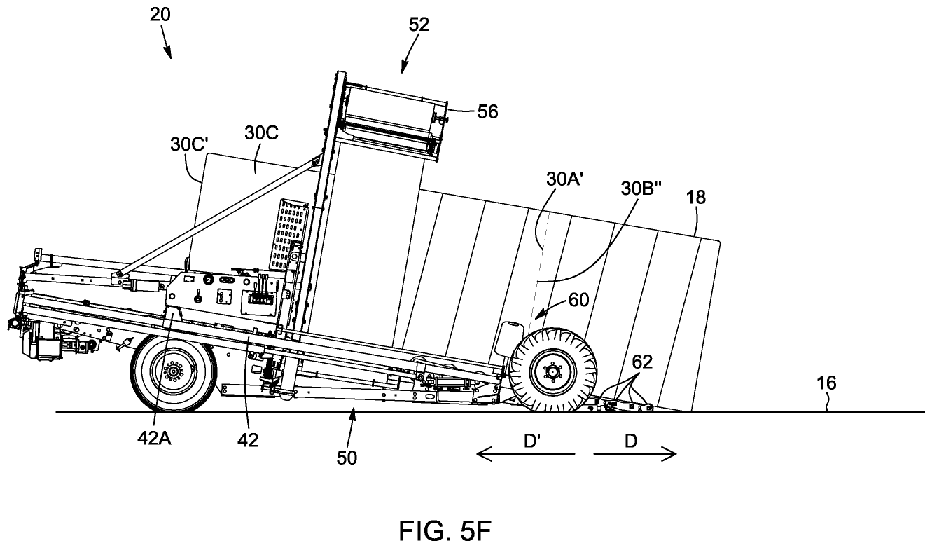

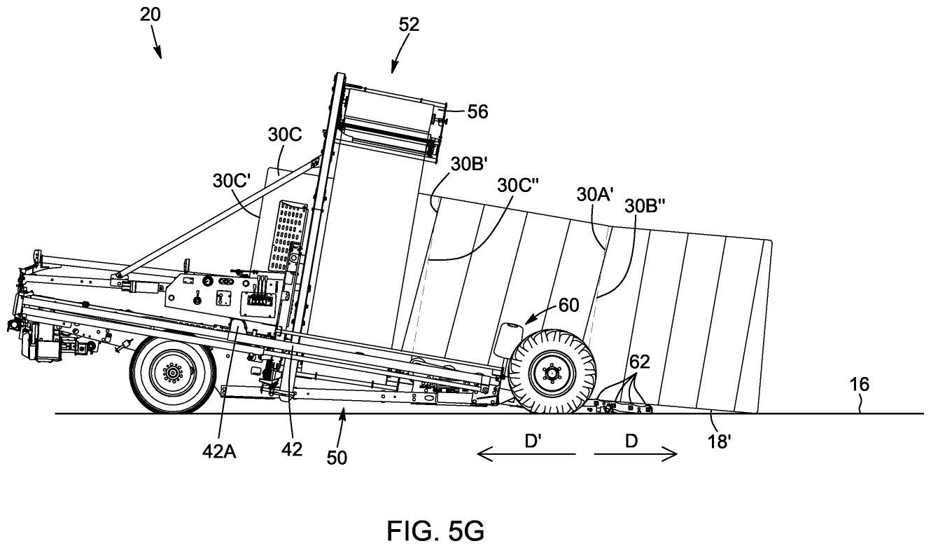

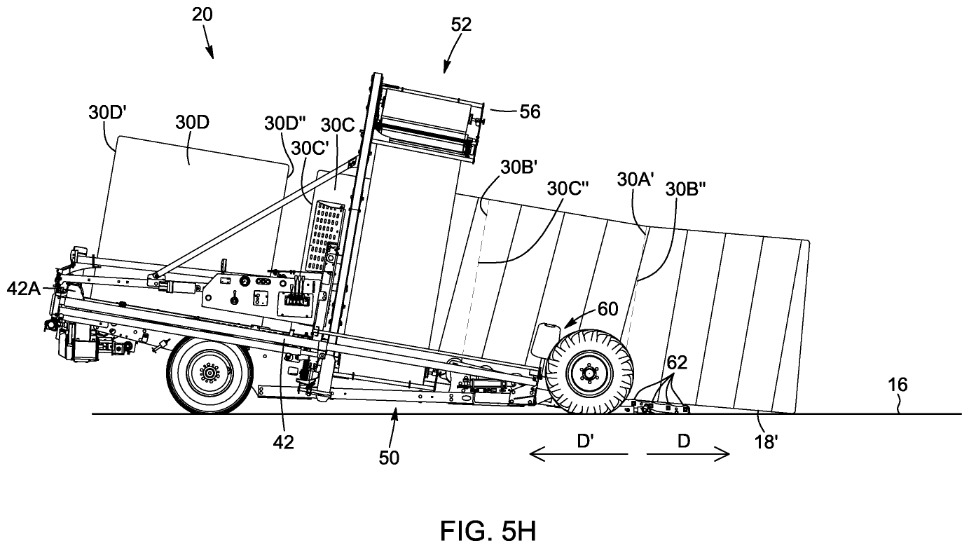

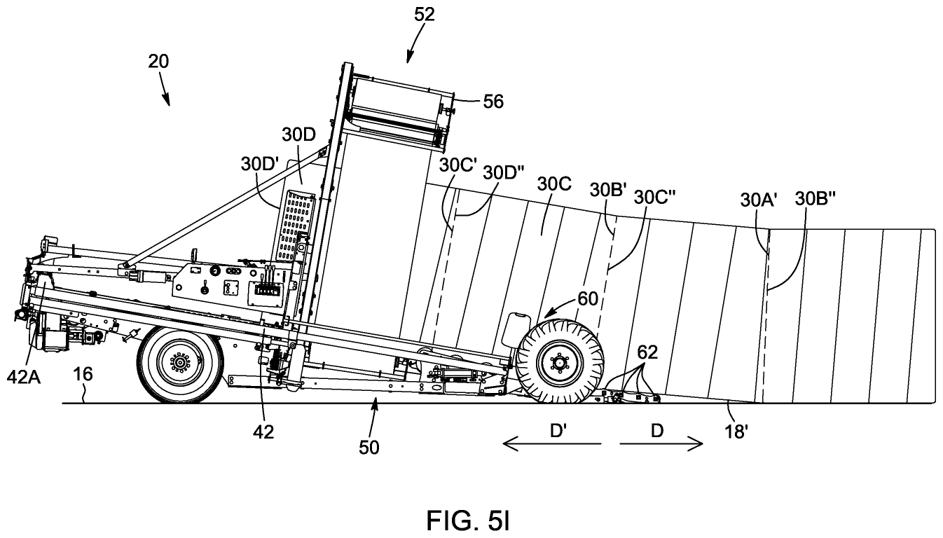

Referring now to FIGS. 5A to 5I, a sequence of operations of the inline bale wrapping apparatus 20 for wrapping the multiple bales 30A, 30B, 30C, 30D successively in the single tube 18 is shown. As mentioned above, one skilled in the art will understand that the number of multiple bales 30A, 30B, 30C, 30D which can be wrapped successively is only indicative and is not limited by the embodiment shown in the Figures.

FIGS. 5A and 5B show the wrapping apparatus 20 with the first bale 30A positioned in the wrapping section 50 and being wrapped by the bale wrapping mechanism 52. The first bale 30A is brought to the wrapping section 50 by being moved in the bale displacement direction D, from the bale loading support structure 40 to the wrapping section 50 by the bale pushing mechanism 42 being moved longitudinally towards the wrapping section 50. The first bale 30A, is driven in the bale displacement direction D, from the bale loading support structure 40 to the wrapping section 50, by the bale engaging member 42A of the bale pushing mechanism 42 engaging a rearward surface (or upstream surface) 30A′ of the first bale 30A and pushing the first bale 30A as it moves towards the wrapping section 50.

FIG. 5C shows the second bale 30B loaded on the bale loading support structure 40, while the first bale 30A is being wrapped. FIG. 5D shows the second bale 30B being moved in the bale displacement direction D, from the bale loading support structure 40 to the wrapping section 50, by the bale pushing mechanism 42 being moved longitudinally towards the wrapping section 50. Once again, the second bale 30B, is driven in the bale displacement direction D, from the bale loading support structure 40 to the wrapping section 50, by the bale engaging member 42A of the bale pushing mechanism 42 engaging a rearward surface (or upstream surface) 30B′ of the second bale 30B and pushing the second bale 30B as it moves towards the wrapping section 50. During the process, a forward surface (or downstream surface) 30B″ of the second bale 30B is pressed against the rearward surface 30A′ of the first bale 30A, such that the second bale 30B pushes the first bale 30A out of the wrapping section 50 and onto the bale unloading support structure 60.

FIGS. 5E and 5F respectively show the third bale 30C loaded on the bale loading support structure 40, while the second bale 30B is being wrapped and the third bale 30C being moved in the bale displacement direction D, from the bale loading support structure 40 towards the wrapping section 50, by the bale pushing mechanism 42 being moved longitudinally towards the wrapping section 50. The third bale 30C, is driven towards the wrapping section 50 by the bale engaging member 42A of the bale pushing mechanism 42 engaging a rearward surface 30C′ of the third bale 30C and pushing the third bale 30C in the bale displacement direction D as it moves towards the wrapping section 50. Once again, during the process, a forward surface 30C″ of the third bale 30C is pressed against the rearward surface 30B′ of the second bale 30B, such that the third bale 30C engages the second bale 30B and starts pushing the second bale 30B out of the wrapping section 50 and onto the bale unloading support structure 60.

At stages shown in FIGS. 5D to 5F, a minimal pressure is required between the second bale 30B and the first bale 30A and between the third bale 30C and the second bale 30B to drive the corresponding downstream bale 30A, 30B forward onto the bale unloading support structure 60, by the force exerted thereon by the corresponding upstream bale 30B, 30C, especially in view of the plurality of free rolling rollers 62 (or alternative conveying elements) favoring the movement of the bales 30A, 30B through the bale unloading support structure 60 and towards the adjacent ground surface 16. As can be seen in FIG. 5F, once a certain quantity of bales 30A, 30B has been wrapped in the wrapping section 50 and transited to the bale unloading support structure 60 to form a section of the tube 18, the first bale 30A of the tube 18 engages the ground surface 16, downstream of the bale unloading support structure 60. In the embodiment shown in the appended Figures (see FIG. 5F), the initial engagement of the first bale 30A of the tube 18 with the ground surface 16 occurs as the first bale 30A and the second bale 30B have been wrapped in the wrapping section 50 and transited to the bale unloading support structure 60 (with the second bale 30B being pushed onto the bale unloading support structure 60 by the third bale 30C being pushed into the wrapping section 50 by the bale pushing mechanism 42). One skilled in the art will however understand that, in alternative embodiments (not shown), the initial engagement of the first bale 30A of the tube 18 with the ground surface 16 could occur after a different quantity of bales have transited onto the bale unloading support structure 60, depending for example and without being limitative on the size of the bales 30A, 30B and the length of the bale unloading support structure 60.

Following the engagement of the first bale 30A of the tube 18 with the ground surface 16, downstream of the bale unloading support structure 60, the bale pushing mechanism 42 of the apparatus 20 operates to further press the abutting surfaces of the first bale 30A, the second bale 30B and the third bale 30C onto one another, and push a growing length of the tube 18 out of the bale unloading support structure 60 in the bale displacement direction D and onto the ground 16 (see FIG. 5G). In conventional inline wrappers, this would lead a downstream section 18′ of the tube 18 to be displace on the ground surface 16, until a sufficient section of tube 18 is laid on the ground 16 to generate the required friction to cause the downstream section 18′ of tube 18 projecting from the apparatus 20 to remain static and generate the required driving force to overcome the inertia of the apparatus 20 and/or the additional restriction to movement thereof and displace the apparatus 20 in an apparatus displacement direction D′.

Referring to FIG. 5G, in the embodiment shown, the displacement assistance system 80 (see FIG. 3) operates to prevent (or at least minimize) the movement of the downstream section 18′ of the tube 18 on the ground surface 16. Indeed, as described above, the displacement assistance system 80 (see FIGS. 2 to 4) operates to assist the movement of the displacement assembly 70 while the bale pushing mechanism 42 and the bale wrapping mechanism 52 are in operation to wrap bale 30C and the downstream section 18′ of the tube 18 is laid on the ground 16. The displacement assistance system 80 operates to ease the displacement of the inline bale wrapping apparatus 20 in the apparatus displacement direction D′ and therefore prevents (or at least minimize) the movement of the downstream section 18′ of the tube 18 onto the ground surface 16.

Hence, in FIG. 5G, the inline bale wrapping apparatus 20 is displaced in the apparatus displacement direction D′ by the tube driving force exerted thereon by the downstream section 18′ of the tube 18 being pushed out of the bale unloading support structure 60 by the action of the bale pushing mechanism 42 on the third bale 30C, with the downstream section 18′ of the tube 18 remaining static with regard to the ground surface 16. It will be understood that the speed of displacement of the apparatus 20 is substantially similar to the speed of displacement of the bales 30A, 30B, 30C along the chassis 32 thereof, to result in minimal movement of the wrapped tube 18 of bales 30A, 30B with regard to the ground surface 16, therefore minimizing the rubbing of the tube 18 onto the ground surface 16 and the undesired damage caused by scrapping of the tube 18 on the ground surface 16.

Similarly, FIGS. 5H and 5I respectively show the fourth bale 30D loaded on the bale loading support structure 40, while the third bale 30C is being wrapped and the fourth bale 30D being moved in the bale displacement direction D, from the bale loading support structure 40 towards the wrapping section 50, by the bale pushing mechanism 42 being moved longitudinally towards the wrapping section 50. The fourth bale 30D is driven towards the wrapping section 50 by the bale engaging member 42A of the bale pushing mechanism 42, engaging a rearward surface 30D′ of the fourth bale 30D and pushing the fourth bale 30D in the bale displacement direction D as it moves towards the wrapping section 50. Once again, during the process, a forward surface 30D″ of the fourth bale 30D is pressed against the rearward surface 30C′ of the third bale 30C, such that the fourth bale 30D engages the third bale 30C and starts pushing the third bale 30C out of the wrapping section 50 and onto the bale unloading support structure 60. The above described action in turn leads to a greater section of the tube 18 being pushed out of the bale unloading support structure 60 and onto the ground surface 16. Once again, the displacement assistance system 80 (see FIGS. 2 to 4) operates to prevent (or at least minimize) the movement of the downstream section 18′ of the tube 18 on the ground surface 16, which leads to the inline bale wrapping apparatus 20 being displaced in the apparatus displacement direction D′ by the driving force exerted thereon by the downstream section 18′ of the tube 18 being pushed out of the bale unloading support structure 60 by the action of the bale pushing mechanism 42 on the fourth bale 30D, with the downstream section 18′ of the tube 18 remaining static with regard to the ground surface 16.

One skilled in the art will understand that, as mentioned above, in an embodiment, the displacement assistance system 80 is activated to operate during an initial phase of the operation of the inline bale wrapping apparatus 20, while the downstream section 18′ of the tube 18 is being laid on the ground surface 16, as shown in FIGS. 5A to 5I. Once a sufficient section of tube 18 is laid on the ground 16 to generate the required friction to cause the downstream section 18′ of tube 18 projecting from the apparatus 20 to remain static and generate the required driving force to overcome the inertia of the apparatus 20 and/or the additional restriction to movement thereof and displace the apparatus 20 in an apparatus displacement direction D′, the displacement assistance system 80 can be deactivated to allow conventional operation of the apparatus 20 where restriction is imparted on the operation of the displacement assembly 70 to result in greater compression between bales. For example and without being limitative, a lever, a push button or the like can be provided to allow an operator to activate/deactivate the operation of the displacement assistance system 80. In an alternative embodiment (not shown), a controller (not shown) can be provided to activate/deactivate the displacement assistance system 80 in accordance with data received from sensor (not shown) sensing data relative to at least one of the bale pushing mechanism 42, the bale wrapping mechanism 42, of the section of tube 18 being laid on the ground 16. As mentioned above, in an embodiment, when activated, the displacement assistance system 80 is operative to assist the movement of the displacement assembly 70 only while the bale pushing mechanism 42 and/or the bale wrapping mechanism 52 are in operation

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

1. An inline bale wrapping apparatus for wrapping multiple successive bales into a tube, the inline bale wrapping apparatus extending along a longitudinal axis and comprising:
a bale loading support structure configured to successively receive unwrapped bales, the bale loading support structure including a bale pushing mechanism movable along the longitudinal axis and engageable to a corresponding one of the unwrapped bales to drive the corresponding one of the unwrapped bales in a bale displacement direction, towards a wrapping section defined downstream of the bale loading structure;
a bale wrapping mechanism positioned in the wrapping section and dispensing wrapping film around the multiple bales being successively driven through the wrapping section to form the tube;
a bale unloading support structure positioned downstream of the wrapping section and receiving wrapped bales forming the tube from the bale wrapping mechanism, the wrapped bales travelling onto the bale unloading support structure towards an adjacent ground surface;
a displacement assembly supporting the bale loading support structure, the bale wrapping mechanism and the bale unloading support structure on the ground surface and being operative to move the inline bale wrapping apparatus in an apparatus displacement direction relative to the ground surface and opposite to the bale displacement direction; and
a displacement assistance system operatively connected to the displacement assembly, the displacement assistance system being activatable to assist the operation of the displacement assembly to minimize a driving force required to move the inline bale wrapping apparatus in the apparatus displacement direction.

2. The inline bale wrapping apparatus of claim 1, wherein the displacement assistance system is deactivatable, the displacement assistance system providing no assistance to the operation of the displacement assembly when being deactivated.

3. The inline bale wrapping apparatus of claim 1, wherein the displacement assembly includes at least one set of motorized moving members, the displacement assistance system activating a motor of the at least one set of motorized moving members, when activated and operating, to assist the movement of the displacement assembly.

4. The inline bale wrapping apparatus of claim 3, wherein the displacement assistance system includes a fluid flow controller controlling a fluid flow to the bale pushing mechanism and the bale wrapping mechanism and wherein the displacement assistance system redirects a portion of the fluid flow of at least one of the bale pushing mechanism and the bale wrapping mechanism towards the at least one set of motorized moving members, when activated and operating.

5. The inline bale wrapping apparatus of claim 1, wherein the displacement assistance system includes a fluid flow controller controlling a fluid flow to the bale pushing mechanism and the bale wrapping mechanism and wherein the fluid flow controller controls a fluid flow towards the at least one set of motorized moving members according to the fluid flow provided to at least one of the bale pushing mechanism and the bale wrapping mechanism, when activated and operating.

6. The inline bale wrapping apparatus of claim 1, wherein the displacement assistance system is operatively connected to the bale pushing mechanism and the bale wrapping mechanism and is operating only during the operation of the bale pushing mechanism and the bale wrapping mechanism.

7. The inline bale wrapping apparatus of claim 1, further comprising a chassis supporting the bale loading support structure, the bale wrapping mechanism and the bale unloading support structure, the displacement assembly being mounted to the chassis and moving the chassis with regards to the ground surface.

8. The inline bale wrapping apparatus of claim 1, wherein the bale pushing mechanism includes a bale engaging member extending upwardly and engageable to a rear surface of the corresponding bale of the unwrapped bales, when the corresponding bale is being driven towards the wrapping section by the action of the bale pushing mechanism.

9. The inline bale wrapping apparatus of claim 1, wherein the bale wrapping mechanism includes a frame having a central bore and at least one film-carrying apparatus drivable along the frame to rotate around the successive bales moved through the central bore and dispense wrapping film around the bales to form the tube.

10. The inline bale wrapping apparatus of claim 1, wherein the bale unloading support structure includes conveying elements allowing free movement of the tube of bales about the bale unloading support structure and towards the adjacent ground surface.

11. An inline bale wrapping apparatus for wrapping multiple successive bales into a tube, the inline bale wrapping apparatus extending along a longitudinal axis and comprising:
a chassis having mounted thereon:
a bale loading support structure receiving unwrapped bales and having a bale pushing mechanism movable along the longitudinal axis and successively pushing the unwrapped bales in a bale displacement direction, towards a wrapping section defined immediately downstream of the bale loading structure;
a bale wrapping mechanism positioned in the wrapping section and dispensing wrapping film around bales positioned in the wrapping section to form the tube;
a bale unloading support structure immediately downstream of the wrapping section and receiving the tube of bales from the bale wrapping mechanism, the tube of bales traveling onto the bale unloading support structure towards an adjacent ground surface and generating a tube driving force exerted in a direction opposite to the bale displacement direction;
a displacement assembly supporting the chassis on the ground surface and operative to move the chassis in an apparatus displacement direction relative to the ground surface and opposite to the bale displacement direction; and
a displacement assistance system operatively connected to the displacement assembly, the displacement assistance system being activatable to assist the operation of the displacement assembly to minimize the tube driving force required to to move the chassis in the apparatus displacement direction.

12. The inline bale wrapping apparatus of claim 11, wherein the displacement assistance system is deactivatable, the displacement assistance system providing no assistance to the operation of the displacement assembly when being deactivated.

13. The inline bale wrapping apparatus of claim 11, wherein the displacement assembly includes at least one set of motorized moving members, the displacement assistance system activating a motor of the at least one set of motorized moving members, when activated and operating, to assist the movement of the displacement assembly.

14. The inline bale wrapping apparatus of claim 13, wherein the displacement assistance system includes a fluid flow controller controlling a fluid flow to the bale pushing mechanism and the bale wrapping mechanism and wherein the displacement assistance system redirects a portion of the fluid flow of at least one of the bale pushing mechanism and the bale wrapping mechanism towards the at least one set of motorized moving members, when activated and operating.

15. The inline bale wrapping apparatus of claim 13, wherein the displacement assistance system includes a fluid flow controller controlling a fluid flow to the bale pushing mechanism and the bale wrapping mechanism and wherein the fluid flow controller controls a fluid flow towards the at least one set of moving members according to the fluid flow provided to at least one of the bale pushing mechanism and the bale wrapping mechanism, when activated and operating.

16. The inline bale wrapping apparatus of claim 11, wherein the displacement assistance system is operatively connected to the bale pushing mechanism and the bale wrapping mechanism and is operating only during the operation of the bale pushing mechanism and the bale wrapping mechanism.

17. The inline bale wrapping apparatus of claim 11, wherein the bale pushing mechanism includes a bale engaging member extending upwardly and engageable to a rear surface of each corresponding unwrapped bales, when the corresponding bale is being pushed towards the wrapping section by the action of the bale pushing mechanism.

18. The inline bale wrapping apparatus of claim 11, wherein the bale wrapping mechanism includes a frame having a central bore and at least one film-carrying apparatus drivable along the frame to rotate around the bales moved through the central bore and dispense wrapping film around the bales to form the tube.

19. The inline bale wrapping apparatus of claim 11, wherein the bale unloading support structure includes conveying elements allowing free movement of the tube of bales about the bale unloading support structure and towards the adjacent ground surface.
